(19) United States
(12) Patent Application Publication
(10) Pub. No.: US 2019/0118159 A1
(43) Pub. Date: Apr. 25, 2019

(54) CALCIUM OXIDE COMPOSTIONS

(71) Applicant: Carmeuse North America, Pittsburgh, PA (US)

(72) Inventors: Carl Petrisko Laird, White Oak, PA (US); Lance Olson, Cranberry Township, PA (US)

(73) Assignee: Carmeuse North America, Pittsburgh, PA (US)

(21) Appl. No.: 16/306,698

(22) PCT Filed: Jun. 5, 2017
(86) PCT No.: PCT/US17/35924

§ 371 Date: Dec. 3, 2018

Related U.S. Application Data
(60) Provisional application No. 62/345,272, filed on Jun. 3, 2016.

(51) Int. Cl. B01J 20/04; B01D 53/50; B01D 53/83; C01F 11/04; C04B 2/04; B01J 20/28; B01J 20/30

(52) U.S. Cl. CPC B01J 20/041; C01P 2006/90; B01D 53/83; C01F 11/04; C04B 2/045; B01J 20/28059; B01J 20/28061; B01J 20/28073; B01J 20/28071; B01J 20/28083; B01J 20/28016; B01J 20/28004; B01J 20/3085; B01J 20/3021; B01J 20/3078; B01D 2251/404; B01D 2251/602; B01D 2257/302; B01D 2257/2045; C01P 2004/61; C01P 2006/12; C01P 2006/14; C01P 2006/16; B01D 53/508

(57) ABSTRACT

An acid gas absorption composition may generally comprise calcium oxide generally characterized by a specific surface area from 40-100 m²/g, a porous volume from 0.25-0.50 cm³/g within a pore diameter range up to 1200 Angstroms, more than 40% by weight of the composition of pores having a diameter from 100-400 Angstroms, and an acid gas mass absorption capacity of at least 4.5 grams of acid gas per 100 grams of composition. Methods of making and using the same are also described.

### CROSS-REFERENCE TO RELATED APPLICATION

This application is a § 371 national stage application of PCT application Serial No. PCT/US2017/035924, filed on Jun. 5, 2017, which claims priority to U.S. provisional application Ser. No. 62/345,272, filed on Jun. 3, 2016, each of which is hereby incorporated by reference in its entirety.

### BACKGROUND

The present invention generally relates to calcium oxide compositions and methods of making and using the same.

Acid gases, such as sulfur trioxide, sulfur dioxide, hydrogen chloride and hydrogen fluoride, may be generated by manufacturing processes. For example, sulfur dioxide may be discharged in the flue gases from power plants generating electricity by the combustion of fossil fuels, such as coal, oil and natural gas. The control of air pollution resulting from the discharge of acid gases into the atmosphere has become increasingly urgent. Conventional flue gas desulfurization technologies may be used to remove, or “scrub”, sulfur dioxide from these emissions. Sodium-based flue desulfurization technologies, such as sodium bicarbonate dry sorbent injection (“DSI”), have a greater affinity for sulfur dioxide relative to lime or limestone DSI. However, sodium-based DSI technologies may generate gaseous nitric oxide (NO₂) and/or increase leaching of coal combustion by-products, such as selenium, when disposed in a landfill. Accordingly, more efficient and/or cost effective compositions and processes for use in the removal of acid gases may be desirable.

### SUMMARY

An acid gas absorption composition may generally comprise calcium oxide generally characterized by a specific surface area from 40-100 m²/g, a porous volume from 0.25-0.50 cm³/g within a pore diameter range up to 1200 Angstroms, more than 40% by weight of the composition of pores having a diameter from 100-400 Angstroms, and an acid gas mass absorption capacity of at least 4.5 grams of acid gas per 100 grams of composition.

A method of preparing an acid gas absorption composition may generally comprise hydrating a starting material to generate calcium hydroxide having a residual moisture content from 18-27% by weight of the composition, wherein the starting material comprises calcium oxide characterized by a size less than 10 mm and a reactivity to water less than 40° C./min; drying the calcium hydroxide to a temperature from 400-510° C. and having a residual moisture content of less than 2% by weight of the composition, wherein the calcium hydroxide is characterized by a specific surface area of 40-55 m²/g and a porous volume less than 0.25 cm³/g within a pore diameter range up to 1200 Angstroms; and milling the calcium hydroxide to produce a mixture comprising at least 90% by weight of the composition having a size of less than 32 micrometers to generate the composition, wherein the composition is characterized by a specific surface area from 40-100 m²/g, a porous volume from 0.25-0.50 cm³/g within a pore diameter range up to 1200 Angstroms, more than 40% by weight of the composition of pores having a diameter from 100-400 Angstroms, and an acid gas mass absorption capacity of at least 4.5 grams acid gas per 100 grams composition.

A method of absorbing acid gases may generally comprise injecting an acid gas absorption composition into a flue duct carrying a flue gas having acid gas, wherein the acid gas absorption composition comprises calcium oxide that may be generally characterized by a specific surface area from 40-100 m²/g, a porous volume from 0.25-0.50 cm³/g within a pore diameter range up to 1200 Angstroms, more than 40% by weight of the composition of pores having a diameter from 100-400 Angstroms, and an acid gas mass absorption capacity of at least 4.5 grams of acid gas per 100 grams composition, and reacting the composition with the acid gas in the flue gas to generate a calcium reaction product, and thereby reducing the concentration of the acid gas in the flue gas.

### DESCRIPTION OF FIGURES

The embodiments described herein may be better understood by reference to the accompanying figures, in which:

FIGS. 1-3 illustrate activated hydrated lime;

FIGS. 4 and 5 illustrate high pore volume lime;

FIG. 6 illustrates a method of preparing an acid gas absorption composition according to the present invention;

FIGS. 7 and 8 include charts comparing the in-flight capture performance of an acid gas absorption composition according to the present invention and conventional sorbent compositions;

FIG. 9 includes a chart comparing the sulfur dioxide absorption of an acid gas absorption composition according to the present invention and conventional sorbent compositions; and

FIGS. 10 and 11 include charts of pore volume within a pore diameter range up to 1200 Angstroms v. average particle diameter size for an acid gas absorption composition according to the present invention and conventional sorbent compositions.

### DETAILED DESCRIPTION

All numerical quantities stated herein are approximate, unless indicated otherwise, and are to be understood as being prefaced and modified in all instances by the term “about”. The numerical quantities disclosed herein are to be understood as not being strictly limited to the exact numerical values recited. Instead, unless indicated otherwise, each numerical value included in this disclosure is intended to mean both the recited value and a functionally equivalent range surrounding that value.

All numerical ranges recited herein include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

As generally used herein, the articles “one”, “a”, “an”, and “the” include “at least one” or “one or more” of what is claimed or described, unless indicated otherwise. For example, “a component” means one or more components, and thus, possibly, more than one component is contemplated and may be employed or used in an implementation of the described embodiments.

As generally used herein, the terms “include”, “includes”, and “including” are meant to be non-limiting.

As generally used herein, the terms “have”, “has”, and “having” are meant to be non-limiting.

As generally used herein, the term “characterized by” is meant to be non-limiting.

Acid gas absorption compositions as generally described herein may be used to remove acid gases from a combustion gas stream. Examples of acid gases in a combustion gas stream include, but are not limited to, sulfur trioxide, sulfur dioxide, hydrogen chloride, and hydrogen fluoride.

An acid gas absorption composition comprising calcium oxide may be generally characterized by one or more of the following characteristics: a moisture content of less than 2% by weight of the composition, a specific surface area from 40-100 m²/g, a porous volume from 0.25-0.50 cm³/g within a pore diameter range up to 1200 Angstroms, more than 40% by weight of the composition of pores having a diameter from 100-400 Angstroms, and an acid gas mass absorption capacity of at least 4.5 grams of acid gas per 100 grams composition.

The acid gas absorption composition may comprise partially calcined calcium oxide or fully calcined calcium oxide. A partially calcined calcium oxide mixture may comprise, based on total weight of the composition, less than 100%, and preferably at least 5 to less than 100%, of calcium hydroxide calcined to calcium oxide. Fully calcined calcium oxide mixture may comprise up to 100%, based on total weight of the composition, of calcium hydroxide calcined to calcium oxide. The acid gas absorption composition may comprise, based on total weight of the composition, at least 5% calcined calcium hydroxide and up to 95% calcined calcium hydroxide. For example, the acid gas absorption composition may comprise, based on total weight of the composition, 5-95%, 10-90%, 20-80%, 25-75%, 40-60% and 100% calcined calcium oxide, and 5-95%, 10-90%, 20-80%, 25-75%, 40-60% and 0% calcium hydroxide. The acid gas absorption composition may be substantially free, essentially free, and completely free of calcium hydroxide. The phrase “substantially free” as used herein refers to the compositions having 8 wt.% or less, “essentially free” means less than 5 wt. % and “completely free” means less than 1 wt. %. The composition may comprise, based on total weight of the composition, 5-95% calcium oxide, and preferably 20-95% calcium oxide, and a balance of residual impurities including uncalcined material, such as calcium carbonate and calcium hydroxide.

The acid gas absorption composition may comprise a free moisture content of up to 2% by weight of the composition, from greater than zero up to 2%, up to 0.5%, and from greater than zero up to 0.5%. The free moisture content may be zero or greater than zero based on the composition's affinity for water, which may be absorbed from the atmosphere after being processed.

The acid gas absorption composition may comprise a specific surface area from greater than 40 to 100 m²/g, and preferably from 60-90 m²/g.

The acid gas absorption composition may comprise a porous volume from at least 0.2 cm³/g, preferably from 0.25-0.50 cm³/g, and more preferably from 0.30-0.50 cm³/g within a pore diameter range up to 1200 Angstroms. The acid gas absorption composition may comprise more than 40%, preferably 40-100%, and more preferably 60-80% by weight of the composition of pores having a diameter of up to 400 Angstroms, preferably 100-400 Angstroms, and more preferably 100-300 Angstroms. For example, the acid gas absorption composition may comprise a porous volume from 0.2-0.40 cm³/g and 60-80% by weight of the composition of pores having a diameter from 100-400 Angstroms.

The acid gas absorption composition may comprise an acid gas mass absorption capacity of greater than 4.0 grams of acid gas per 100 grams unreacted composition, preferably 4.5 to 5.0 grams of acid gas per 100 grams unreacted composition, and more preferably greater than 5.0 grams of acid gas per 100 grams unreacted composition. The acid gas absorption composition may comprise a sulfur dioxide mass absorption capacity of greater than 4.0 grams of sulfur per 100 grams unreacted composition, preferably 4.5 to 5.0 grams of sulfur per 100 grams unreacted composition, and more preferably greater than 5.0 grams of sulfur per 100 grams unreacted composition. The acid gas absorption capacity of the acid gas absorption composition may relate to the increase in the weight of the unreacted composition after reacting with the acid gas. For example, referring to Table 7, the reacted composition may have a 4.82% and 5.83% increase by weight of the unreacted composition after reacting with the acid gas.

The acid gas absorption composition may comprise a mixture of calcium oxide having a particle size distribution of at least 90 weight percent, based on the total weight of the mixture, of particles having a size of less than 32 micrometers and a balance of particles having a size equal to or greater than 32 micrometers. Preferably the mixture may comprise at least 95 weight percent, based on the total weight of the mixture, of particles having a size of less than 32 micrometers and a balance of particles having a size equal to or greater than 32 micrometers. More preferably, the mixture may comprise at least 99 weight percent, based on the total weight of the mixture, of particles having a size of less than 32 micrometers and a balance of particles having a size equal to or greater than 32 micrometers. Even more preferably, the mixture may comprise 90-95 weight percent, based on the total weight of the mixture, of particles having a size of less than 32 micrometers and a balance of particles having a size equal to or greater than 32 micrometers. Still more preferably, the mixture may comprise 95-98 weight percent, based on the total weight of the mixture, of particles having a size of less than 32 micrometers and a balance of particles having a size equal to or greater than 32 micrometers. The weight percentage of the particles is based on the fraction passing 32 micrometers using a laser diffraction method.

An acid gas absorption composition may be prepared by a process comprising: hydrating a starting material to generate calcium hydroxide having a residual moisture content from 18-27% by weight of the composition, wherein the starting material comprises calcium oxide characterized by a size less than 10 mm and a reactivity to water less than 40° C./min; drying the calcium hydroxide to a residual moisture content of less than 2% by weight of the composition, wherein the calcium hydroxide is characterized by a specific surface area of 40-55 m²/g and a porous volume less than 0.25 cm³/g within a pore diameter range up to 1200 Angstroms; milling the calcium hydroxide to at least 90% percent, based on the total weight of the mixture, having a size of less than 32 micrometers; and calcining, based on the total weight of the mixture, at least a 5%portion of the calcium hydroxide to generate the composition.

The starting material may comprise calcium oxide. The starting material may comprise impurities, including one or more of calcium carbonate, magnesium oxide, sulfur, silica, iron, and alumina. The total content of the impurities may be no more than 12% by weight of the composition. The composition may comprise, based on total weight of the composition, up to 1.2% calcium carbonate, up to 9.0% magnesium oxide, up to 0.06% sulfur, up to 1.6% silica, up to 0.25% iron, and up to 0.5% alumina. The starting material may be characterized by one or more of the following characteristics: a size from greater than zero up to 10 mm by mechanical sieve shaker and preferably greater than zero up to 2 mm, a reactivity to water from 10-40° C./min and preferably 15-35° C./min, and a residual moisture content from 18-27% by weight of the composition and preferably 18-21% by weight of the composition.

The calcium hydroxide may comprise a residual moisture content less than 2% by weight of the composition and preferably 0-1% by weight of the composition, a specific surface area of 40-55 m²/g and preferably 50 m²/g, and a porous volume less than 0.25 cm³/g within a pore diameter range up to 1200 Angstroms and preferably 20 cm³/g within a pore diameter range up to 1200 Angstroms.

The calcining step may comprise contacting the calcium hydroxide and a heated gaseous stream for a time sufficient to heat the calcium hydroxide to 400-510° C. and preferably 400-425° C. The time may be from 0.5 seconds to 4 hours and preferably 90 minutes or less depending on calcination device's efficiency. The calcining step may comprise contacting the calcium hydroxide and a heated gaseous stream for 3 hours to heat the calcium hydroxide to 400-410° C. The calcining step may comprise partially or fully calcining the calcium hydroxide by direct contact in a calciner including a furnace and a reactor having a temperature from 400-510° C. in which the calcination may take place. The calciner may comprise one of a fluidized calciner, a flash calciner, a rotary calciner, a disk calciner, a kettle calciner, a hearth calciner, an expansion calciner, and a static bed calciner, and may be fuel-fired or electrically heated. The composition may not directly contact the combustion products.

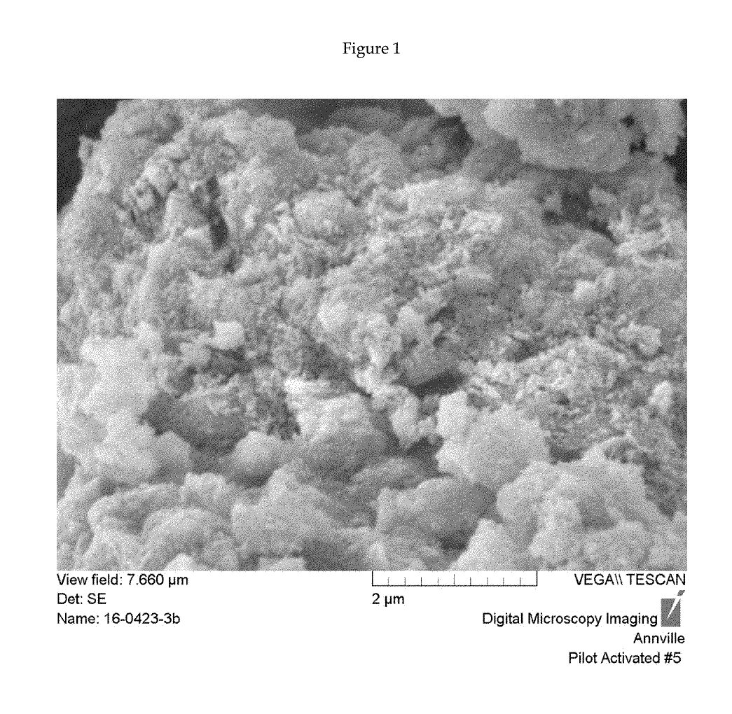

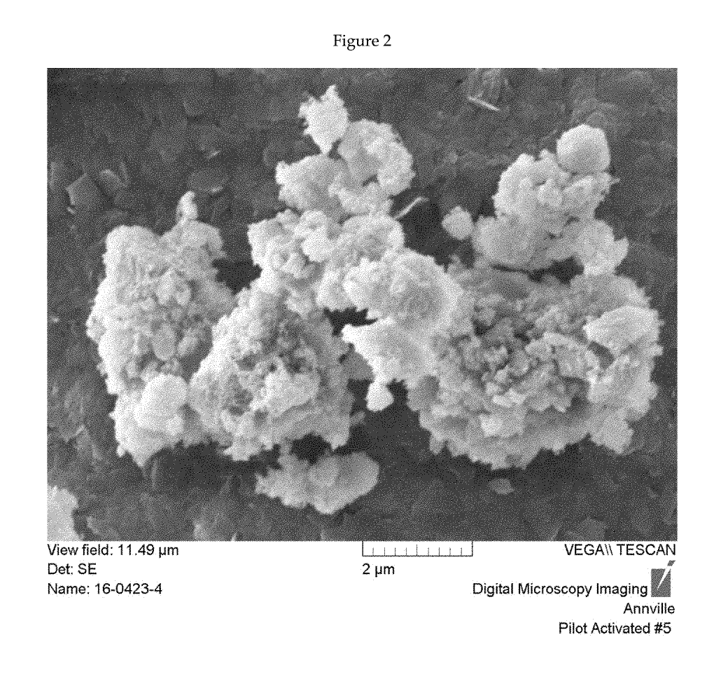

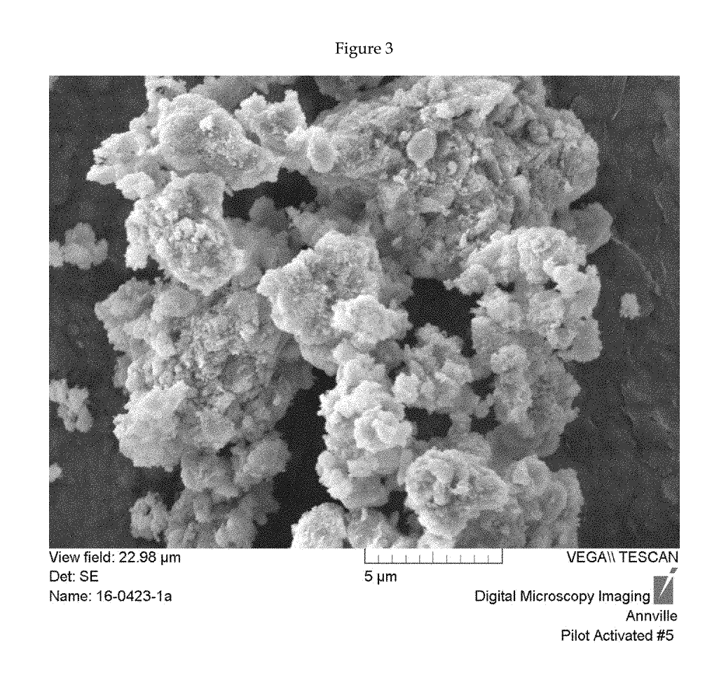

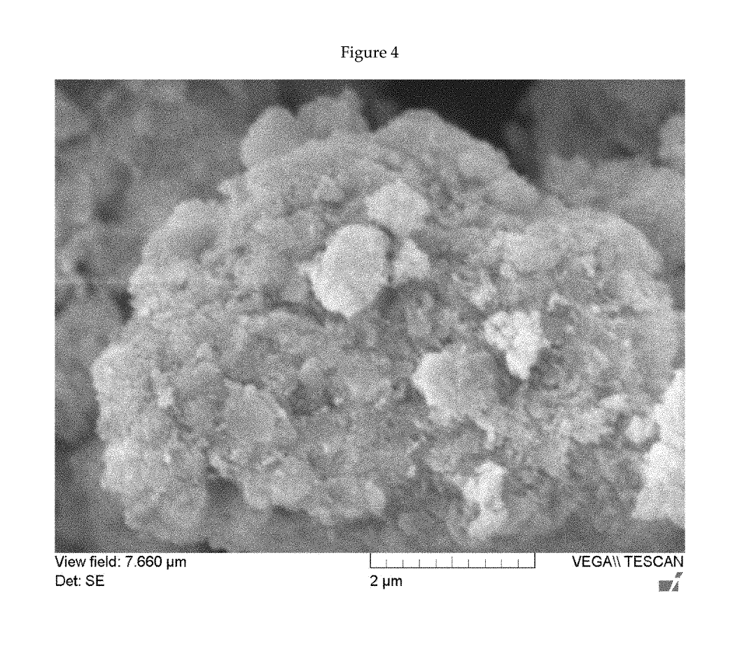

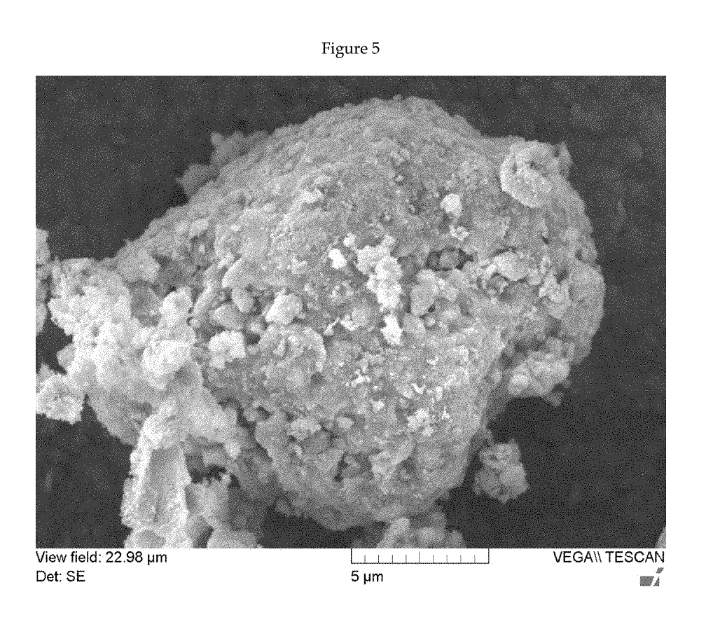

Without wishing to be bound to any particular theory, the acid gas absorption composition according to the present invention illustrated in FIGS. 1-3 may be characterized by a greater porous volume and an optimized pore diameter from 100-400 Angstroms, and thereby a greater specific surface area relative to conventional acid gas absorption compositions illustrated in FIGS. 4 and 5. The porous volume and pore diameter may generally depend on the calcining temperature and time. The absorption capacity of the composition may be greater than the calcium hydroxide's absorption capacity prior to calcining. The absorption capacity of the composition may be substantially equal to or greater than conventional sodium absorption compositions.

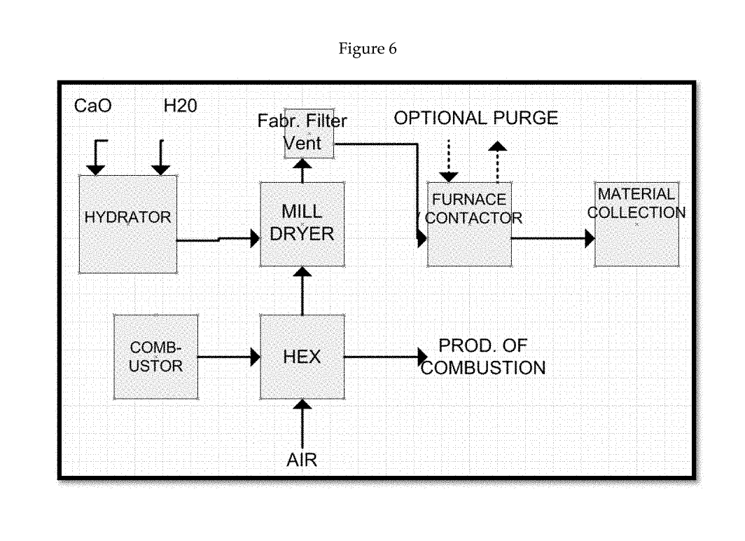

Referring to FIG. 6, a method of preparing an acid gas absorption composition may generally comprise contacting a starting material, such as calcium oxide (“CaO”), and water (“H₂O”) in a hydrator to produce calcium hydroxide. The method may comprise drying and milling the calcium hydroxide in separate steps or simultaneously in the same step; contacting at least a portion of the calcium hydroxide and a heated gaseous stream in a nitrogen purged laboratory muffle furnace to produce the acid gas absorption composition; collecting the acid gas absorption composition (“MATERIAL COLLECTION”); and heating the acid gas absorption composition in a combustor that may burn fuel to produce heat to produce the calcium hydroxide and by-products. The by-products of the combustor (“PROD. OF COMBUSTION”) may comprise gaseous products, including more than 400 ppm carbon dioxide. The fuel for the combustor may comprise coal, oil, or gas. The heat exchanger (“HEX”) may heat atmospheric air (“AIR”). The heat exchanger may be connected to the apparatus (“MILL DRYER”) to provide it with the heated air. The milled and dried composition may be collected in a fabric filter (“Fabr. Filter Vent”) having a greater than 95% collection efficiency.

A method of preparing an acid gas absorption composition may generally comprise hydrating a starting material to generate calcium hydroxide having a residual moisture content from 18-27% by weight of the composition, wherein the starting material comprises calcium oxide characterized by a size less than 10 mm and a reactivity to water less than 40° C./min; drying the calcium hydroxide to a residual moisture content of less than 2% by weight of the composition, wherein the calcium hydroxide is characterized by a specific surface area of 40-55 m²/g and a porous volume less than 0.25 m²/g within a pore diameter range up to 1200 Angstroms; milling the calcium hydroxide to, based on the total weight of the mixture, at least 90 weight percent having a size of less than 32 micrometers; and contacting at least a portion of the calcium hydroxide and a heated gaseous stream for a time sufficient to heat the calcium hydroxide to 400-510° C. to generate the composition, wherein the composition is characterized by a specific surface area from 40-100 m²/g, a porous volume from 0.25-0.50 cm³/g within a pore diameter range up to 1200 Angstroms, and more than 40% by weight of the composition of pores having a diameter from 100-400 Angstroms, and an acid gas mass absorption capacity of at least 4.5 grams acid gas reaction product per 100 grams composition.

The acid gas absorption composition may comprise a sulfur mass absorption capacity of at least 4.5 grams acid gas reaction product per 100 grams composition, such as 4.5-6 grams SOₓ, where x=2 or 3, per 100 grams composition when the acid gas comprises sulfur dioxide and/or sulfur trioxide.

The acid gas absorption composition may comprise a relative acid gas absorption capacity of at least 3 relative to calcium hydroxide. The composition may comprise a relative sulfur absorption capacity of at least 3 relative to calcium hydroxide. For example, referring to Table 7, conventional hydrated lime may have a sulfur mass absorption capacity of 1.67 grams acid gas reaction product per 100 grams composition and an acid gas absorption composition according to the present inventions may have a sulfur mass absorption capacity of 5.84 grams acid gas reaction product per 100 grams composition, and thereby, a relative acid gas absorption capacity of 3.5 relative to calcium hydroxide.

The gaseous stream may comprise a temperature from 390-510° C. and preferably 400-425° C.

The calcium hydroxide may be heated to a temperature from 390-510° C. and preferably 400-425° C.

The time may be from 0.5 second to 4 hours, preferably less than 3 hours, and more preferably less than 90 minutes.

The gaseous stream may comprise air and/or an inert gas comprising at least one of nitrogen and argon.

The method may comprise collecting the composition from the gaseous stream. The composition may be collected using a fabric filter having at least 95% collection efficiency.

A method of absorbing an acid gas from a flue gas may generally comprise injecting an acid gas absorption composition into a flue duct carrying the flue gas; reacting the composition with an acid gas in the flue gas to generate a calcium reaction product, and thereby reducing the concentration of the acid gas in the flue gas. The calcium reaction product may comprise calcium sulfite, calcium sulfate, calcium chloride, calcium fluoride and mixtures thereof.

The method may comprise collecting the reaction product and any unreacted composition. A particulate collection device may comprise an electrostatic precipitator, a fabric filter, and a cyclonic device.

The concentration of the composition may be characterized by a removal efficiency based on a ratio of composition mass injected into a duct per unit time as compared to mass per unit time of SO₂ before injection point (sorbent mass/SO₂ inlet mass) basis up to 10, preferably greater than zero up to 5, and more preferably 0.5 to 4.

The injection rate of the composition into a flue duct may comprise less than 16,000 lbs/hr and preferably 6,000-10,000 lbs/hr.

The method may comprise reacting the composition with an acid gas in the flue gas to reduce acid gas emissions by at least 25% when measured against emissions observed without the use of the composition. The method comprising reacting the composition with SO₂ and/or SO₃in the flue gas may reduce SO₂ and/or SO₃ emissions by at least 25% when measured against emissions observed without the use of the composition.

An acid gas absorption composition for use in the removal of acid gases from a combustion gas stream may be prepared by fully or partially, thermally decomposing calcium hydroxide (hydrated lime) to calcium oxide by contacting the calcium hydroxide and a heated gas stream at a temperature such that the calcium oxide achieves an internal temperature of 750-950° F. for a time sufficient to produce a calcium oxide having a specific surface area of 40-100 m²/g with a porous volume of 0.25-0.50 cm³/g within a pore diameter range up to 1200 Angstroms; and collecting the resultant material so produced for use later in contact with a combustion or process gas stream to remove acid gases therefrom. The method may comprise partially calcining the calcium hydroxide to produce a mixture comprising, by weight of the mixture, 5-95% calcium oxide. The method may comprise fully calcining the calcium hydroxide to produce a mixture comprising, by weight of the mixture, up to 100% calcium oxide.

The absorption of acid gases by the composition may be improved by the synergistic effect of the total BET specific surface area of 40-100 m²/g, BJH pore volume of 0.25-0.50 cm³/g within a pore diameter range up to 1200 Angstroms, and more than 40% by weight of the composition having a diameter from 100-400 Angstroms. Without wishing to be bound to any particular theory, the total BET specific surface area, total BJH pore volume, and a porous volume may work together in a synergistic manner and that when all three elements are present in specific, controlled amounts, which even greater improvements in acid gas absorption properties may be obtained. These results are obtained with values that are more than additive of the results expected of each element individually. This synergistic effect may be achieved while maintaining other desired properties such moisture content and particle size.

The total BET specific surface area, total BJH pore volume, and a porous volume within a pore diameter range from 100-400 Angstroms for (1) hydrated lime, (2) representative comparative examples, and (3) acid gas compositions according to the present invention are shown in Table 1. The total BET specific surface area, BJH pore volume, and porous volume within a pore diameter range from 100-400 Angstroms of standard hydrated lime is 18 m²/g, 0.08 cm³/g, and 0.05 cm³/g, respectively. The FGT Grade Hydrated Lime has a total BET specific surface area of 22 m²/g and a BJH pore volume of 0.1 cm³/g. The total BET specific surface area, BJH pore volume, and porous volume within a pore diameter range from 100-400 Angstroms of the Enhanced Hydrated Lime is 37 m²/g, 0.22 cm³/g, and 0.16 cm³/g, respectively. The total BET specific surface area, a BJH pore volume, and porous volume within a pore diameter range from 100-400 Angstroms for Original Activated Lime is 46 m²/g, 0.15 cm³/g, and 0.09 cm³/g, respectively. The total BET specific surface area and BJH pore volume of the Original Activated Lime MAX is 61 m²/g and 0.19 cm³/g. The Improved Activated Lime 1 has a total BET specific surface area of, a BJH pore volume of, and a porous volume within a pore diameter range from 100-400 Angstroms of 59 m²/g, 0.30 cm³/g, and 0.25 cm³/g, respectively. The Improved Activated Lime 2 has a total BET specific surface area of 90 m²/g, a BJH pore volume of 0.40 cm³/g, and a porous volume 0.30 cm³/g within a pore diameter range from 100-400 Angstroms. The total BET specific surface area and BJH pore volume of the Improved Activated Lime 3 is 64 m²/g and 0.39 cm3/g.

TABLE 1

| | BET | BJH | BJH Pore |
|---|---|---|---|
| | Specific | Cumulative | Volume |
| | Surface | Pore | between |
| | Area | Volume | 100-400 Å |
| Sample | (m²/g) | (cm³/g) | (cm³/g) |
| Standard Hydrated Lime | 18 | 0.08 | 0.05 |
| FGT Grade Hydrated Lime | 22 | 0.1 | — |
| Enhanced Hydrated Lime | 37 | 0.22 | 0.16 |
| Original Activated Lime | 46 | 0.15 | 0.09 |
| Original Activated Lime MAX | 61 | 0.19 | — |
| Improved Activated Lime 1 | 59 | 0.30 | 0.25 |
| Improved Activated Lime 2 | 90 | 0.40 | 0.30 |
| Improved Activated Lime 3 | 64 | 0.39 | — |

### EXAMPLES

The present invention may be better understood when read in conjunction with one or more of the following representative examples. The following examples are included for purposes of illustration and not limitation.

### Example 1

A starting material comprising calcium oxide (CaO) having a size less than 10 mm and a reactivity to water less than 40° C./min is hydrated with excess water to produce calcium hydroxide having a residual moisture content from 18-21% by weight of the total starting material (Step 1). The calcium hydroxide is dried and milled during the same step with heated air to produce an acid absorption composition comprising calcium hydroxide characterized by a residual moisture content of less than 2% by weight of the total starting material, a specific surface area of 50 m²/g, a total nitrogen adsorption pore volume from 0.19-0.23 cm³/g (Step 2) within a pore diameter range up to 1200 Angstroms. The acid absorption composition may be further characterized as comprising more than 90% fraction of particles of size less than 32 micrometers.

The calcium hydroxide from Step 2 is heated at a temperature from 750° F. to 900° F. in an electronic furnace purged with nitrogen for a time from 60 minutes to 1050 minutes to produce a material that is partially to fully calcined back to CaO characterized by a specific surface area from 45 m²/g to 90 m²/g and a porous volume from 0.25 cm³/g to 0.40 cm³/g within a pore diameter range up to 1200 Angstroms.

The acid absorption composition produced in Step 3 is collected by scoopula and tested for sulfur dioxide (SO₂) reaction performance at a temperature from 302° F. to 750° F. in two devices.

Device 1: 1600 ppm SO₂, balance nitrogen (998,400 ppm N₂), is passed over a measured amount of the acid absorption composition in a Mettler Toledo DSC TGA for 1 hour at a specified temperature. The amount of absorbed sulfur is determined and a reaction rate is calculated.

Device 2: The acid absorption composition is injected in a dry sorbent injection pilot plant consisting of 1700 SO₂ ppm and a simulated pulverized coal combustion (“PCC”) flue gas composition at a specific injection temperature. The PCC flue gas may be produced by a pulverized coal combustion boiler. The acid absorption composition remains “in-flight” for two to three seconds wherein the reaction between the acid absorption composition and simulated PCC flue gas composition occurs. The gas concentration is measured before and after injection points to determine removal efficiency on a (sorbent mass/SO_{2 inlet} mass) basis.

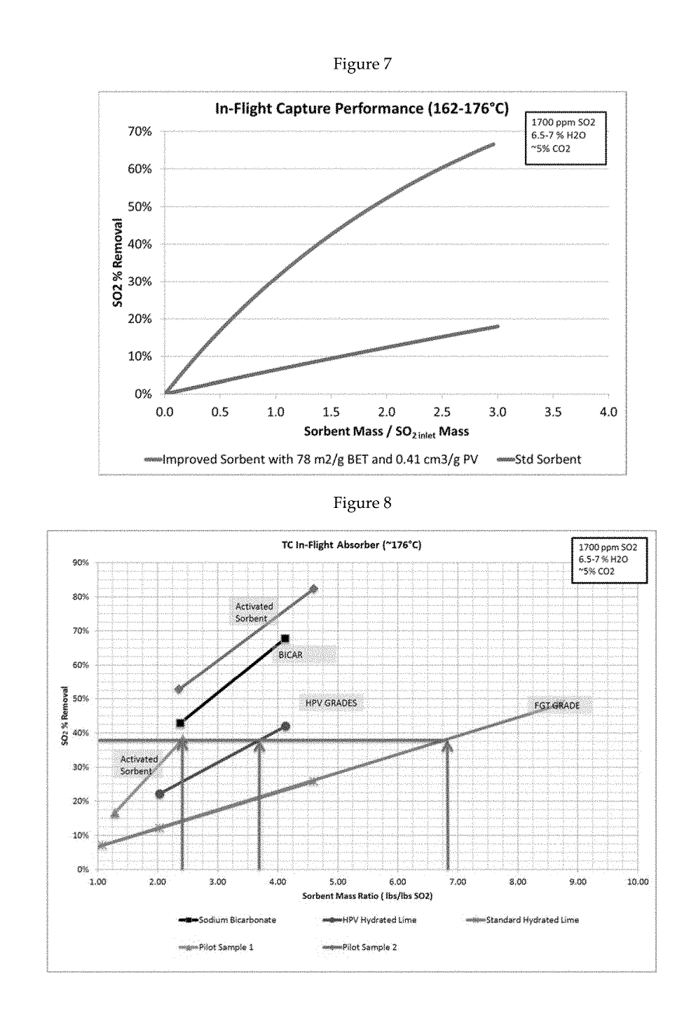

Referring to FIG. 7, the acid gas absorption composition characterized by a total BET specific surface area of 78 m²/g and a pore volume of 0.41 cm³/g within a pore diameter range up to 1200 Angstroms exhibited a greater removal efficiency on a (sorbent mass/SO_{2 inlet} mass) basis relative to a conventional acid gas absorption composition. Each sample was injected in a dry sorbent injection pilot plant consisting of 1700 SO₂ ppm, 6.5-7% H₂O, and 5% CO₂ and a simulated PCC flue gas composition at a specific injection temperature.

Referring to FIG. 8, the acid gas absorption composition according to the present invention (Activated Sorbent) is characterized by 15-82% removal efficiency and 1.25 to 4.6 lbs/lbs SO2. Activated Sorbent (Pilot Sample 1) can be further characterized by a total BET specific surface area of 63 m2/g and a pore volume of 0.38 cm3/g within a pore diameter range up to 1200 Angstroms. Activated Sorbent (Pilot Sample 2) can be further characterized by a total BET specific surface area of 70 m2/g and a pore volume of 0.41 cm3/g within a pore diameter range up to 1200 Angstroms. Conventional acid gas absorption compositions are characterized by 7.5-50% removal efficiency and 1 to 8.75 lbs/lbs SO2 (FGT Grade), 22.5-42.5% removal efficiency and 2 to 4.25 lbs/lbs SO2 (HPV Grades), and 42.5-67.5% removal efficiency and 2.5 to 4.25 lbs/lbs SO2 (BICAR).

### Example 2

Sulfur dioxide acid gas absorption tests were conducted using thermogravimetric analysis (“TGA”) to measure the acid gas absorption capacities and rates of acid gas absorption of hydrated lime and activated lime. The Original Activated Lime and Original Activated Lime MAX were prepared. The hydrated lime had a BET specific surface area of 18 m²/g and porous volume of 0.08 cm³/g within a pore diameter range up to 1200 Angstroms. The hydrated lime was heated to 763-772° F. in a nitrogen purged laboratory muffle furnace for 50 and 85 minutes, respectively. The Original Activated Lime, Original Activated Lime MAX, Standard Hydrated Lime, FGT Hydrated Lime, and Enhanced Hydrated Lime were each analyzed for specific surface area (nitrogen absorption using a Brunauer, Emmett and Teller model) and pore volume (Barett, Joyner and Halenda model) using a Micrometrics Tri Star 3000 surface area and porosity analyzer. Without wishing to be bound to any particular theory, it is believed that the greater the total BET specific surface area, total BJH pore volume, and porous volume within a pore diameter range 100-400 Angstroms, the more effective the acid absorption composition absorbs acid gases. Table 2 shows that the acid absorption composition according to the present inventions increased the specific surface area from 18 m²/g to 46-61 m²/g and increased the pore volume from 0.08 cm³/g to 0.15-0.19 cm³/g relative to commercially available hydrated lime.

Sulfur dioxide absorption tests were then carried out. A one gram sample of the hydrated lime or activated lime prepared as described above was placed in a Mettler Toledo DSC Thermo Graphic Analyzer for one hour at a temperature of 302° F. 1600 ppm SO₂, balance nitrogen, was passed over the measured amount of acid absorption composition. A reaction rate was calculated based on amount of weight gained over time. The sample was then removed from the TGA and analyzed for sulfur content as shown in Table 2.

TABLE 2

| | BET | BJH | | | |
|---|---|---|---|---|---|
| | Specific | Cumulative | | Increase | |
| | Surface | Pore | | in | Relative |
| | Area | Volume | wt % | Weight % | absorption |
| Sample | (m²/g) | (cm³/g) | Ca(OH)² | Sulfur | of Sulfur |
| Standard Hydrated Lime | 18 | 0.08 | 88 | 1.67 | 1 |
| FGT Grade Hydrated Lime | 22 | 0.10 | 93 | 2.43 | 1.46 |
| Enhanced Hydrated Lime | 37 | 0.22 | 93 | 3.74 | 2.24 |
| Original Activated Lime | 46 | 0.15 | 41 | 4.21 | 2.52 |
| Original Activated Lime | 61 | 0.19 | 7 | 4.57 | 2.74 |
| MAX | | | | | |

### Example 3

Sulfur dioxide absorption test according to Example 2 was conducted for activated lime prepared from a different sample of hydrated lime than was used in Example 2. To prepare the Improved Activated Lime 1 for the absorption test, a previously prepared hydrated lime having a BET SSA of 51 m²/g, porous volume of 0.20 cm³/g within a pore diameter range up to 1200 Angstroms, and more than 90% fraction of particles of size less than 32 microns was heated to 797° F. in a nitrogen purged laboratory muffle furnace for one hour. The Improved Activated Lime 1 was analyzed for BET specific surface area and BJH pore volume as in Example 2. Table 3 shows that the Improved Activated Lime 1 had increased the BET specific surface area from 51 m²/g to 59 m²/g and increased the BJH pore volume from 0.20 cm³/g to 0.30 cm³/g. The TGA absorption test was carried out as described for Example 2. Table 3 also shows that the Improved Activated Lime 1 absorbed more SO₂ than the hydrated or activated lime in Example 2.

TABLE 3

| | BET | BJH | | | |
|---|---|---|---|---|---|
| | Specific | Cumulative | | Increase | |
| | Surface | Pore | | in | Relative |
| | Area | Volume | wt % | Weight % | absorption |
| Sample | (m²/g) | (cm³/g) | Ca(OH)2 | Sulfur | of Sulfur |
| Improved | 59 | 0.30 | 58 | 4.82 | 2.89 |
| Activated | | | | | |
| Lime 1 | | | | | |

### Example 4

Sulfur dioxide absorption test according to Example 3 was conducted by TGA with activated lime prepared from the same sample of hydrated lime used in Example 3. The Improved Activated Lime 2 was prepared by heating the hydrated lime from Example 3 to a temperature of 763° F. in a nitrogen purged laboratory muffle furnace for 180 minutes. The Improved Activated Lime 2 was analyzed for BET specific surface area and BJH pore volume according to Example 2. Table 4 shows that Improved Activated Lime 2 increased the BET specific surface area from 51 m²/g to 90 m²/g and increased the BJH pore volume from 0.20 cm³/g to 0.40 cm³/g. The TGA absorption test was carried out as described in Example 2. Table 3 also shows that the Improved Activated Lime 2 absorbed more SO₂ than the hydrated and activated limes in Example 1 and 2.

TABLE 4

| | BET | BJH | | | |
|---|---|---|---|---|---|
| | Specific | Cumulative | | Increase | |
| | Surface | Pore | | in | Relative |
| | Area | Volume | wt % | Weight % | absorption |
| Sample | (m²/g) | (cm³/g) | Ca(OH)2 | Sulfur | of Sulfur |
| Improved | 90 | 0.40 | 16 | 5.83 | 3.49 |
| Activated | | | | | |
| Lime 2 | | | | | |

### Example 5

A SO₂ acid gas absorption test was conducted on a pilot scale with activated lime prepared from the same sample of hydrated lime used in Example 3. Improved Activated Lime 3 was prepared by heating the hydrated lime from Example 3 to 797° F. in a nitrogen purged laboratory muffle furnace for 150 minutes. Improved Activated Lime 3 was analyzed for BET specific surface area and BJH pore volume as in Example 2. Table 5 shows that Improved Activated Lime 3 increased the BET specific surface area from 51 m²/g to 78 m²/g and increased the BJH pore volume from 0.20 cm³/g to 0.41 cm³/g. The dry sorbent injection pilot plant test was carried out by injecting Improved Activated Lime 3 into a simulated PCC flue gas composition having 1700 SO2 ppmv at 350° F. The Improved Activated Lime 3 remained “in-flight” for 2-3 seconds where the reaction between the Improved Activated Lime 3 and simulated PCC flue gas occurred. Gas concentration is measured before and after injection points by a Teledyne T100H UVF Analyzer and Gasmet DX4000 FTIR, respectively, to determine removal efficiency on a (sorbent mass/SO₂ inlet mass) basis. FIG. 7 shows that Improved Activated Lime 3 absorbed more than 300% of SO₂ compared to referenced standard commercial hydrated lime.

TABLE 5

| | BET | BJH | | | |
|---|---|---|---|---|---|
| | Specific | Cumulative | | Increase | |
| | Surface | Pore | | in | Relative |
| | Area | Volume | wt % | Weight % | absorption |
| Sample | (m²/g) | (cm³/g) | Ca(OH)2 | Sulfur | of Sulfur |
| Standard Hydrated Lime | 18 | 0.08 | 88 | 1.67 | 1 |
| FGT Grade Hydrated Lime | 22 | 0.10 | 93 | 2.43 | 1.46 |
| Enhanced Hydrated Lime | 37 | 0.22 | 93 | 3.74 | 2.24 |
| Original Activated Lime | 46 | 0.15 | 41 | 4.21 | 2.52 |
| Original Activated Lime | 61 | 0.19 | 7 | 4.57 | 2.74 |
| MAX | | | | | |
| Improved Activated | 59 | 0.30 | 58 | 4.82 | 2.89 |
| Lime 1 | | | | | |
| Improved Activated | 90 | 0.40 | 16 | 5.83 | 3.49 |
| Lime 2 | | | | | |
| Improved Activated | 78 | 0.41 | 21 | — | — |
| Lime 3 | | | | | |

### Example 6

The 0% calcined enhanced hydrated lime is characterized by a BET specific surface area from 51.7 m²/g, a BJH pore volume from 0.208 cm³/g, and an increase of weight % sulfur of 4.11. Five samples were prepared by heating the starting material to temperatures of 369° C. for 90 minutes, 399° C. for 90 minutes, 409° C. for 120 minutes, 410° C. for 180 minutes, and 406° C. for 180 minutes, respectively, in a nitrogen purged laboratory muffle furnace. Table 6 shows that materials calcined at higher temperatures and longer periods of time exhibited improved absorption of sulfur dioxide.

TABLE 6

| | | | | | | | | Barrett- | |
|---|---|---|---|---|---|---|---|---|---|
| | | | | | | | | Joyner- | |
| | | | | | | | | Halenda | |
| | | | | | | | BET | (BJH) | Increase |
| | | | | | | | Specific | Cumulative | in |
| | | | | | | | Surface | Pore | Weight % |
| | Temperature | Time | % | % | % | % | Area | Volume | Sulfur |
| # | ° C. | Min | Calcined | CaO | Ca(OH)₂ | CaCO₃ | (m²/g) | (cm³/g) | (g) |
| Enhanced | | | 0 | | | | 51.7 | 0.208 | 4.11 |
| Hydrated | | | | | | | | | |
| Lime | | | | | | | | | |
| R27 | 396 | 90 | 40.50 | 28.11 | 54.89 | 5.74 | 73.72 | 0.3155 | 5.15 |
| R28 | 399 | 90 | 8.25 | 1.2 | 84.64 | 3.77 | 43.39 | 0.2098 | 3.84 |
| R29 | 409 | 120 | 62.99 | 48.92 | 34.14 | 4.99 | 84.42 | 0.3774 | 5.51 |
| R30 | 410 | 180 | 81.52 | 65.49 | 17.05 | 4.95 | 82.42 | 0.3829 | 5.54 |
| R31 | 406 | 180 | 83.10 | 67.38 | 15.59 | 4.46 | 89.52 | 0.4041 | 5.84 |

### Example 7

Table 7 shows the improved relative absorption of sulfur of the acid gas absorption composition according to the present invention compared to hydrated lime and conventional acid gas absorbents.

TABLE 7

| | Increase | |
|---|---|---|
| | in Weight % | |
| Standard | Sulfur (g) | Relative Absorption |
| HYDRATED LIME 1 | 1.67 | 1 |
| HYDRATED LIME 2 | 2.4 | 1.44 |
| ENHANCED HYDRATE | 4.11 | 2.46 |
| ORIGINAL PATENT | 4.21 | 2.52 |
| REPRODUCED | | |
| ORIGINAL PATENT MAX | 4.57 | 2.74 |
| ACTIVATED ENHANCED | 5.84 | 3.50 |
| HYDRATE | | |
| Sodium Competitor | 6.79 | 4.07 |

### Example 8

The conventional 0% calcined hydrate lime is characterized by a BET specific surface area from 18.8 m²/g, a BJH pore volume from 0.088 cm³/g, and an increase of weight % sulfur of 1.67. The 0% calcined enhanced hydrated lime is characterized by a BET specific surface area from 51.7 m²/g, a BJH pore volume from 0.208 cm³/g, and an increase of weight % sulfur of 4.11.

### Example 9

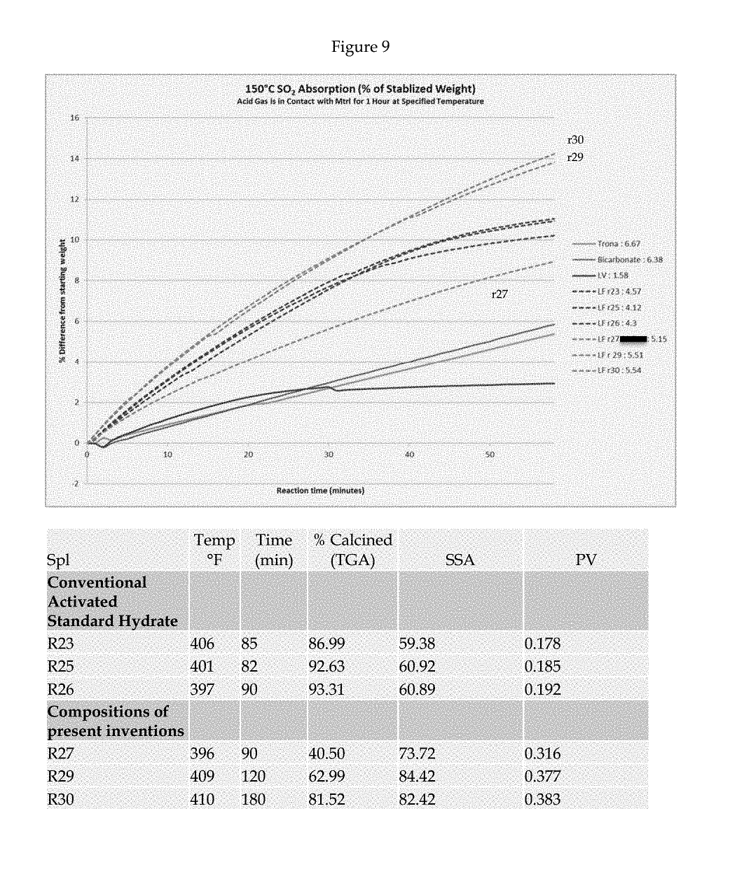

Referring to FIG. 9, compositions according to the present inventions, LF r29: 5.51 and LF r30: 5.54, exhibited a greater removal efficiency on a (sorbent mass/SO_{2 inlet} mass) basis relative to a conventional acid gas absorption compositions LV: 1.58 (commercially available hydrated lime) from a reaction time from 0 to 60 minutes at a temperature of 400° C. Sample R23 was heated to a temperature of 406° C. for 85 minutes to produce an acid gas absorption composition characterized by 86.99% calcined, a BET specific surface area of 59.38 m²/g and a BJH pore volume from 0.178 cm³/g, and an increase of weight % sulfur of 4.57. Sample R25 was heated to a temperature of 401° C. for 82 minutes to produce an acid gas absorption composition characterized by 92.63% calcined, a BET specific surface area of 60.92 m²/g and a BJH pore volume from 0.185 cm³/g, and an increase of weight % sulfur of 4.12. Sample R26 was heated to a temperature of 397° C. for 90 minutes to produce an acid gas absorption composition characterized by 93.31% calcined, a BET specific surface area of 60.89 m²/g and a BJH pore volume from 0.192 cm³/g, and an increase of weight % sulfur of 4.3. Sample R27 was heated to a temperature of 396° C. for 90 minutes to produce an acid gas absorption composition characterized by 40.50% calcined, a BET specific surface area of 73.72 m²/g and a BJH pore volume from 0.316 cm³/g, and an increase of weight % sulfur of 5.15. Sample R29 was heated to a temperature of 409° C. for 120 minutes to produce an acid gas absorption composition characterized by 62.99% calcined, a BET specific surface area of 84.42 m²/g and a BJH pore volume from 0.377 cm³/g, and an increase of weight % sulfur of 5.51. Sample R30 was heated to a temperature of 410° C. for 180 minutes to produce an acid gas absorption composition characterized by 81.52% calcined, a BET specific surface area of 82.42 m²/g and a BJH pore volume from 0.383 cm³/g, and an increase of weight % sulfur of 5.54. Sodium sesquicarbonate dihydrate (Trona) had an increase of weight % sulfur of 6.67. Sodium bicarbonate (Bicarbonate) had an increase of weight % sulfur of 6.38.

Without wishing to be bound to any particular theory, it is believed that removal efficiency of the acid gas is related to the initial slope of the acid gas absorption composition because the composition reacts with the acid gas in a few seconds when injected into a flue duct carrying the acid gas. As shown in FIG. 9, LF r29: 5.51 and LF r30: 5.54 each had a greater initial slope relative to the other samples illustrated in FIG. 9 at times less than 10 minutes.

### Example 10

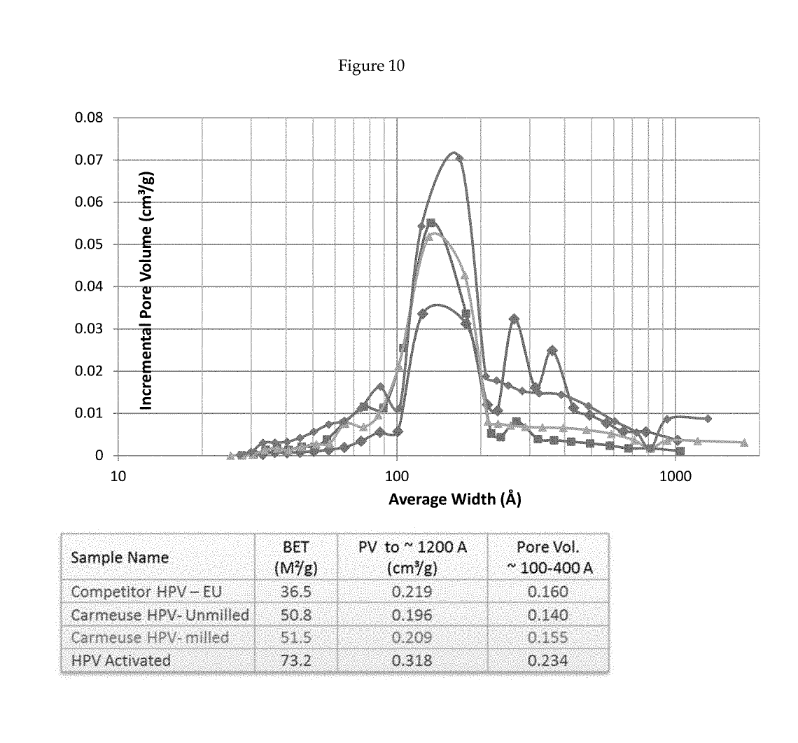

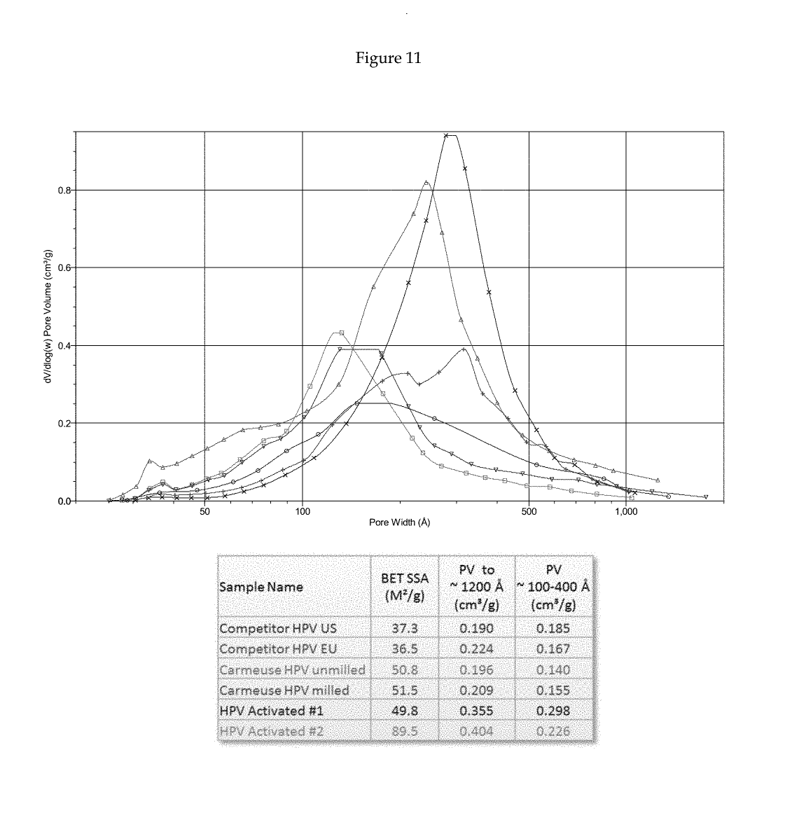

FIG. 10 includes a chart showing the pore volume (cm³/g) versus average width (Angstroms) for an acid gas absorption composition according to the present inventions and conventional acid gas absorption compositions. As shown in FIG. 10, an average width from 100-400 Angstroms produced acid gas absorption composition having the greatest pore volume. The Competitor HPV-EU is characterized by a BET specific surface area of 36.5 m²/g and a BJH pore volume of 0.219 cm³/g, and a pore volume of 0.160 cm³/g within a pore diameter range from 100-400 Angstroms. The Carmeuse HPV-Unmilled is characterized by a BET specific surface area of 50.8 m²/g and a BJH pore volume of 0.196 cm³/g, and a pore volume of 0.140 cm³/g within a pore diameter range from 100-400 Angstroms. The Carmeuse HPV-milled is characterized by a BET specific surface area of 51.5 m²/g and a BJH pore volume of 0.209 cm³/g, and a pore volume of 0.155 cm³/g within a pore diameter range from 100-400 Angstroms. The HPV Activated is characterized by a BET specific surface area of 73.2m²/g and a BJH pore volume of 0.318 cm³/g, and a pore volume of 0.234 cm³/g within a pore diameter range from 100-400 Angstroms. The Competitor HPV-US is characterized by a BET specific surface area of 37.3 m²/g and a BJH pore volume of 0.190 cm³/g, and a pore volume of 0.185 cm³/g within a pore diameter range from 100-400 Angstroms. FIG. 10 shows that increasing the pore diameter to 100-400 Angstrom range provide more active sites capable of reacting with the acid gas, such as sulfur dioxide, for example.

### Example 11

FIG. 11 includes a chart showing the dV/d log(w) pore volume (cm³/g) versus average width (Angstroms) for an acid gas absorption composition according to the present inventions and conventional acid gas absorption compositions. As shown in FIG. 11, an average with from 100-400 Angstroms produced acid gas absorption composition having the greatest pore volume. The Competitor HPV-US is characterized by a BET specific surface area of 37.3 m²/g and a BJH pore volume of 0.190 cm³/g, and a pore volume of 0.185 cm³/g within a pore diameter range from 100-400 Angstroms. The Competitor HPV-EU is characterized by a BET specific surface area of 36.5 m²/g and a BJH pore volume of 0.224 cm³/g, and a pore volume of 0.167 cm³/g within a pore diameter range from 100-400 Angstroms. The Carmeuse HPV-Unmilled is characterized by a BET specific surface area of 50.8 m²/g and a BJH pore volume of 0.196 cm³/g, and a pore volume of 0.140 cm³/g within a pore diameter range from 100-400 Angstroms. The Carmeuse HPV-milled is characterized by a BET specific surface area of 51.5 m²/g and a BJH pore volume of 0.209 cm³/g, and a pore volume of 0.155 cm³/g within a pore diameter range from 100-400 Angstroms. The HPV Activated #1 is characterized by a BET specific surface area of 49.8m²/g and a BJH pore volume of 0.355 cm³/g, and a pore volume of 0.298 cm³/g within a pore diameter range from 100-400 Angstroms. The HPV Activated #2 is characterized by a BET specific surface area of 89.5 m²/g and a BJH pore volume of 0.404 cm³/g, and a pore volume of 0.226 cm³/g within a pore diameter range from 100-400 Angstroms.

Each of the characteristics and aspects described above, and combinations thereof, may be encompassed by the present invention. The present invention is drawn to the following non-limiting aspects:

(1) An acid gas absorption composition comprising calcium oxide, the composition comprising: (a) a specific surface area from 40-100 m²/g; (b) a porous volume from 0.25-0.50 cm³/g; (c) more than 40% by weight of the composition of pores having a diameter from 100-400 Angstroms; and (d) an acid gas mass absorption capacity of at least 4.5 grams acid gas per 100 grams composition.

(2) The composition of aspect 1 wherein the composition comprises: (a) 40-80% by weight of the composition of pores having a diameter from 100-400 Angstroms; (b) 4.5-6 grams acid gas per 100 grams composition; (c) a relative sulfur absorption capacity of at least 3 relative to calcium hydroxide; and (d) at least 25% reduction in SO₂ and/or SO₃ emissions relative to emissions observed without the use of the composition, when the acid gas comprise SO₂and/or SO₃.

(3) The composition of aspects 1 or 2 comprising, based on total weight of the composition, 5-95% calcium oxide, and preferably 20-95% calcium oxide, and a balance of residual impurities.

(4). The composition of aspects 1-3 free, substantially free, or completely free from calcium hydroxide.

(5) The composition of aspects 1-4 comprising calcium hydroxide having a specific surface area from 25-55 m²/g and a porous volume of less than 0.25 cm³/g within a pore diameter range up to 1200 Angstroms.

(6) The composition of aspects 1-5 comprising a mixture comprising a first fraction of particles having a size of less than 32 micrometers and a second fraction of particles of a size greater than 32 micrometers, wherein the weight percent of the first fraction is at least 90 weight percent, based on the total weight of the mixture.

(7) A method of preparing an acid gas absorption composition, the method comprising: (a) hydrating a starting material to generate an intermediate material comprising calcium hydroxide and having a residual moisture content from 18-27% by weight of the intermediate material, wherein the starting material comprises calcium oxide characterized by a size less than 10 mm, a reactivity to water less than 40° C./min; (b) drying the intermediate material to a residual moisture content of less than 2% by weight of the intermediate material, wherein the calcium hydroxide is characterized by a specific surface area of 25-55 m²/g and a porous volume less than 0.25 cm³/g; (c) milling the intermediate material to at least 90% by weight of the mixture having a size of less than 32 micrometers; and (d) contacting at least a portion of the intermediate material and a heated gaseous stream for a time sufficient to heat the intermediate material to 400-510° C. to generate the composition, wherein the composition is characterized by a specific surface area from 40-100 m²/g, a porous volume from 0.25-0.50 cm³/g, more than 40% by weight of the composition of pores with a diameter from 100-400 Angstroms, and an acid gas mass absorption capacity of at least 4.5 grams acid gas per 100 grams composition.

(8) The method of aspect 7 comprising simultaneously drying and milling the intermediate material.

(9) The method of aspect 7 or 8 comprising injecting the composition into a flue duct carrying the flue gas.

(10) The method of aspect 7-9, wherein the gaseous stream is from 390-510° C., and preferably 400-425° C.; and wherein the gaseous stream is air or an inert gas.

(11) The method of aspect 7-10, wherein the acid gas absorption composition is the composition of claim 1.

(12) A method of absorbing an acid gas from a flue gas the method comprising: (a) injecting the acid gas absorption composition of claim 1 into a flue duct carrying the flue gas; (b) reacting the composition with the acid gas in the flue gas to generate a reaction product including at least one of a calcium sulfate, a calcium sulfite, and a calcium chloride, and thereby reducing the concentration of acid gas in the flue gas.

(13) The method of aspect 12, wherein the composition is characterized by a removal efficiency on a (sorbent mass/acid gas inlet mass) basis up to 10.

(14) The method of aspects 12 or 13, wherein an injection rate of the composition is less than 16,000 lbs/hr.

(15) The method of aspects 12-14, wherein reacting the composition with HCl, SO₂ and/or SO₃ in the flue gas reduces HCl, SO₂ and/or SO₃ emissions by at least 25% when measured against emissions observed without the use of the composition, when the acid gas comprise HCl, SO₂ and/or SO₃.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

What is claimed is:

1. An acid gas absorption composition comprising calcium oxide, the composition comprising:
(a) a specific surface area from 40-100 m²/g;
(b) a porous volume from 0.25-0.50 cm³/g;
(c) more than 40% by weight of the composition of pores having a diameter from 100-400 Angstroms; and
(d) an acid gas mass absorption capacity of at least 4.5 grams acid gas per 100 grams composition.

2. The composition of claim 1 wherein the composition comprises:
(a) 40-80% by weight of the composition of pores having a diameter from 100-400 Angstroms;
(b) 4.5-6 grams acid gas per 100 grams composition;
(c) a relative sulfur absorption capacity of at least 3 relative to calcium hydroxide; and
(d) at least 25% reduction in SO₂ and/or SO₃ emissions relative to emissions observed without the use of the composition, when the acid gas comprise SO₂and/or SO₃.

3. The composition of claim 1 comprising, based on total weight of the composition, 5-95% calcium oxide and a balance of residual impurities.

4. The composition of claim 1 substantially free from calcium hydroxide.

5. The composition of claim 1 comprising calcium hydroxide having a specific surface area from 25-55 m²/g and a porous volume of less than 0.25 cm³/g within a pore diameter range up to 1200 Angstroms.

6. The composition of claim 1 comprising a mixture comprising a first fraction of particles having a size of less than 32 micrometers and a second fraction of particles of a size greater than 32 micrometers, wherein the weight percent of the first fraction is at least 90 weight percent, based on the total weight of the mixture.

7. A method of preparing an acid gas absorption composition, the method comprising:
(a) hydrating a starting material to generate an intermediate material comprising calcium hydroxide and having a residual moisture content from 18-27% by weight of the intermediate material, wherein the starting material comprises calcium oxide characterized by a size less than 10 mm, a reactivity to water less than 40° C./min;
(b) drying the intermediate material to a residual moisture content of less than 2% by weight of the intermediate material, wherein the calcium hydroxide is characterized by a specific surface area of 25-55 m²/g and a porous volume less than 0.25 cm³/g;
(c) milling the intermediate material to at least 90% by weight of the mixture having a size of less than 32 micrometers; and
(d) contacting at least a portion of the intermediate material and a heated gaseous stream for a time sufficient to heat the intermediate material to 400-510° C. to generate the composition, wherein the composition is characterized by a specific surface area from 40-100 m²/g, a porous volume from 0.25-0.50 cm³/g, more than 40% by weight of the composition of pores with a diameter from 100-400 Angstroms, and an acid gas mass absorption capacity of at least 4.5 grams acid gas per 100 grams composition.

8. The method of claim 7 comprising simultaneously drying and milling the intermediate material.

9. The method of claim 7 comprising injecting the composition into a flue duct carrying the flue gas.

10. The method of claim 7,
(a) wherein the gaseous stream is from 390-510° C., and preferably 400-425° C.; and
(b) wherein the gaseous stream is air or an inert gas.

11. A method of absorbing an acid gas from a flue gas the method comprising:
(a) injecting the acid gas absorption composition of claim 1 into a flue duct carrying the flue gas;
(b) reacting the composition with the acid gas in the flue gas to generate a reaction product including at least one of a calcium sulfate, a calcium sulfite, and a calcium chloride, and thereby reducing the concentration of acid gas in the flue gas.

12. The method of claim 11, wherein the composition is characterized by a removal efficiency on a (sorbent mass/acid gas inlet mass) basis up to 10.

13. The method of claim 11, wherein an injection rate of the composition is less than 16,000 lbs/hr.

14. The method of claim 11, wherein reacting the composition with HCl, SO₂ and/or SO₃ in the flue gas reduces HCl, SO₂ and/or SO₃ emissions by at least 25% when measured against emissions observed without the use of the composition, when the acid gas comprise HCl, SO₂ and/or SO₃.
